(19) United States
(12) Patent Application Publication
(10) Pub. No.: US 2014/0114720 A1
(43) Pub. Date: Apr. 24, 2014

(54) APPARATUS AND METHOD FOR PROCESSING MARKET DATA

(71) Applicant: THE ROYAL BANK OF SCOTLAND PLC, Edinburgh (GB)

(72) Inventors: Paul Thind, Hong Kong (HK); Leslie Ching, Hong Kong (HK)

(73) Assignee: THE ROYAL BANK OF SCOTLAND PLC, Edinburgh (GB)

(21) Appl. No.: 13/654,753

(22) Filed: Oct. 18, 2012

(51) Int. Cl. G06Q 30/02

(52) U.S. Cl. 705/7.28

(57) ABSTRACT

An apparatus, method and non-transitory computer-readable storage medium for processing market data. The apparatus may comprise a risk analyzer arranged to access a first set of time-series market data from a data source and to process said first set of time-series market data to generate data indicative of a risk category. The apparatus may also have a trend analyzer arranged to access said data indicative of a risk category determined by the risk analyzer and to output a value of a market indicator based on a second set of time-series market data. The trend analyzer may be arranged to determine the value of the market indicator using an output of a set of filters and the set of filters may be selected by the trend analyzer according to said data indicative of a risk category.

### TECHNICAL FIELD

The present disclosure relates to an apparatus, method and non-transitory computer-readable storage medium for processing market data.

### BACKGROUND

Market data comes in many different forms. It underlies millions of financial transactions that are performed every day. One form of market data comprises a number of data points or values. The data points may comprise measurements and/or metrics. For example, they may comprise financial and/or operating characteristics of a commercial entity, such as, amongst many others, share price, earnings per share, revenues, profit and liquidity ratios, or values of tradeable objects such as assets and commodities. They may also comprise information published by governments or information providers such as, amongst many others, employment and gross domestic product measures, consumer price indices, interest rates, production rates, and exchange rates. Typically a data point or value has an associated date and/or time. This may be a date and/or time of measurement or, in some cases, of publication. A plurality of such data points thus generates time-series data.

Market data may also comprise data points or values that are based on data from multiple underlying data sources. For example, certain organizations generate financial indices from a plurality of data sources. Some indices such as the Global Dow, FTSE 100 and the NASDAQ Composite track the performance of share prices of selected commercial entities. There are a variety of indices based on different industries and geographical areas.

Market data is often complex and chaotic. It often has characteristics that appear random, yet typically represents an integration of data from casually interconnected entities. This makes it difficult to process. Whereas radio-frequency signals may comprise a voltage that varies in time according to predictable rules, thus allowing reliable actions in telecommunication systems, it is difficult to undertake reliable actions based on time-series market data. These actions may comprise, in certain cases, the trading of one or more tradeable objects on an electronic wading platform.

### SUMMARY

According to a first example, there is provided apparatus for processing time-series market data comprising a risk analyzer arranged to access a first set of time-series market data from a data source and to process said first set of time-series market data to generate data indicative of a risk category and a trend analyzer arranged to access said data indicative of a risk category determined by the risk analyzer and to output a value of a market indicator based on a second set of time-series market data, the trend analyzer being arranged to determine the value of the market indicator using an output of a set of filters, the set of filters being selected by the trend analyzer according to said data indicative of a risk category.

According to a second example, there is provided a method of processing market data comprising processing a first set of time-series market data accessed from a data source to generate data indicative of a risk category and determining a value of a market indicator based on a second set of time-series market data. Said determining comprises accessing said data indicative of a risk category, selecting a set of filters according to said data indicative of a risk category, applying at least the selected set of filters to the second set of time-series market data, and determining the value of the market indicator using an output of said selected set of filters.

A non-transitory computer-readable storage medium comprising a set of computer-readable instructions stored thereon, may be used which, when executed by a processing system, cause the processing system to perform a method according to the second example.

According to a third example, there is provided an apparatus for generating data indicative of a market allocation for one or more tradeable objects comprising a trend analyzer arranged to receive a first set of one or more data streams comprising market data and to generate data indicative of a value of a market indicator, the market indicator representing a predicted future trend and being used to determine data indicative of a market allocation for one or more tradeable objects; and a technical filter arranged to receive a second set of one or more data streams comprising market data and to apply at least a risk classification to said second set of one or more data streams to generate one or more signals for use in modulating said data indicative of a market allocation for the one or more tradeable objects, the risk classification comprising the determination of a risk category, wherein the apparatus is arranged to use the output of the trend analyzer and the output of the technical filter to output data indicative of a modulated market allocation for the one or more tradeable objects.

According to a fourth example, there is provided a method of generating data indicative of a market allocation for one or more tradeable objects comprising processing a first set of one or more data streams comprising market data to generate data indicative of a value of a market indicator, the market indicator representing a predicted future trend and being used to determine data indicative of a market allocation for one or more tradeable objects, processing a second set of one or more data streams comprising market data, including applying at least a risk classification to said second set of one or more data streams to generate one or more signals for use in modulating said data indicative of a market allocation for the one or more tradeable objects, the risk classification comprising the determination of a risk category and outputting data indicative of a modulated market allocation for the one or more tradeable objects based on the processing of the first and second sets of one or more data streams.

Further features and advantages of the disclosure will become apparent from the following description of illustrative examples of the disclosure, given by way of example only, which is made with reference to the accompanying drawings.

### BRIEF DESCRIPTION OF THE DRAWINGS

FIG. 1 is a schematic diagram showing an apparatus for processing market data according to an example;

FIG. 2 is a schematic diagram showing an apparatus for processing market data according to an example;

FIG. 3 is a schematic diagram showing a risk analyzer according to an example;

FIG. 4A is a schematic diagram showing a first trend analyzer according to an example;

FIG. 4B is a schematic diagram showing a second trend analyzer according to an example;

FIG. 5A is a flow diagram showing a first method for processing market data according to an example;

FIG. 5B is a flow diagram showing a set of flow blocks for the first exemplary method;

FIG. 6 is a flow diagram showing a second method for processing market data according to an example;

FIG. 7 is a flow diagram showing a third method for processing market data according to an example;

FIG. 8A is a chart showing a first example of different risk categories for a set of time-series market data;

FIG. 8B is a chart showing a second example of different risk categories for a set of time-series market data;

FIG. 8C is a chart showing a third example of different risk categories for a set of time-series market data;

FIG. 9 is a chart showing different volatility ranges that may be used to implement a volatility controller according to an example;

FIG. 10 is a schematic diagram showing a further apparatus for processing market data according to a first example;

FIG. 11 is a schematic diagram showing a further apparatus for processing market data according to a second example;

FIG. 12 is a schematic diagram showing a further apparatus for processing market data according to a third example; and

FIG. 13 is a flow diagram showing a further method for processing market data according to an example.

### DETAILED DESCRIPTION

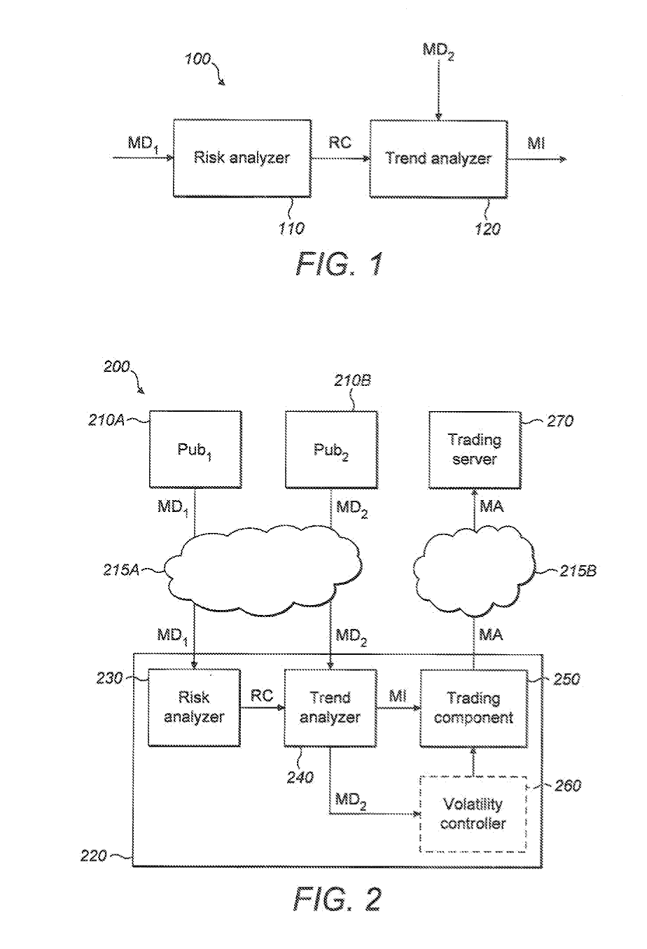

FIG. 1 is a schematic diagram of an apparatus 100 for processing market data according to an example. The apparatus 100 comprises a risk analyzer 110 and a trend analyzer 120. The risk analyzer 110 of FIG. 1 is arranged and constructed to receive a first set of market data MD₁. The risk analyzer 110 is arranged and constructed to process the first set of market data MD₁ and generate data indicative of a risk category RC. The trend analyzer 120 of FIG. 1 is communicatively coupled to the risk analyzer 110 of FIG. 1. The trend analyzer 120 is arranged and constructed to receive the data indicative of a risk category RC from the risk analyzer 110 of FIG. 1. The trend analyzer 120 is further arranged and constructed to receive a second set of market data MD₂, use the data indicative of a risk category RC to configure processing of the second set of market data MD₂ and output a market indicator MI. The first and second sets of market data MD₁ and MD₂ may comprise time-series data.

The market indicator MI of FIG. 1 is a data variable representative of a state of the second set of market data MD₂. In certain cases, it is representative of a state of the second set of market data MD₂ at a particular date and/or time. In certain cases, it is a position indicator representative of a position to take with respect to the second set of market data MD₂. It may comprise a discrete variable with a set number of values or a continuous variable, such as a continuous variable within a fixed range. In certain examples, the trend analyzer 120 of FIG. 1 uses a risk category determined by the risk analyzer 110 (as represented by data RC) to select a generation procedure for generating a value for the market indicator MI based on the second set of market data MD₂. The risk category determined based on the first set of market data MD₁ sets a reference state for the second set of market data MD₂. This enables a suitable set of calculations for the market indicator MI to be selected based on the reference state. For example, a risk category may be indicative of one of a high risk state or regime and a low risk state or regime. A given set of calculations may be more robust, i.e. less likely to produce erroneous results, in a particular one of the high or low risk states. This set of calculations can thus be appropriately applied by the trend analyzer 120.

The first and second sets of market data MD₁ and MD₂ may be associated (e.g. one may have a material effect on the other). For example, the first set of market data MD₁ may comprise an index for a first set of commercial entities in a first geographical area and the second set of market data MD₁ may comprise an index for a second set of commercial entities in a second geographical area, wherein the constituent elements in both sets of commercial entities at least partially overlap and/or the territories in both geographical areas at least partially overlap. Or the first set of market data MD₁ may comprise an employment metric for a geographical area and the second set of market data MD₁ may comprise a share price for at least one commercial entity in the same geographical area. In these examples, there is a causal association between the measurements and/or metrics that constitute the first and second sets of market data MD₁ and MD₂ such that the first set of market data MD₁ can be used as a reference point for the second set of market data MD₂. The causal association may be direct or indirect.

FIG. 2 is a schematic diagram of a system 200 comprising another apparatus 220 for processing market data according to an example. The apparatus 220 may comprise a computing device communicatively coupled to one or more networks. The apparatus of FIG. 2 comprises a risk analyzer 230, a trend analyzer 240, a trading component 250 and a volatility controller 260. The volatility controller 260 may be selectively activated as indicated by a dashed line. The risk analyzer 230 and the trend analyzer 240 may comprise the risk analyzer 110 and the trend analyzer 120 of FIG. 1.

In FIG. 2 the apparatus is communicatively coupled to a first publisher 210A, a second publisher 210B and a trading server 270. The risk analyzer 230 receives a first set of time-series market data MD₁ from the first publisher 210A. The risk analyzer 230 receives the first set of time-series market data MD₁ over a first network 215A. The trend analyzer 240 and the volatility controller 260 receive a second set of time-series market data MD₂ from the second publisher 220A. In FIG. 2, the second set of time-series market data MD₂ is received over the first network 215A; however, it may also be received over a separate network. The trading component 250 communicates a market action MA to the trading server 270 over a second network 215B. The second network 215B may be the same network as the first network 215A. The networks 215 may comprise one or more: public and/or private networks; wired and/or wireless networks; and local, metropolitan and/or wide-area networks. The market action MA may be used to initiate a trade order for one or more tradeable objects hosted on one or more electronic exchanges. The volatility controller 260 may receive the second set of time-series market data MD₂ through the trend analyzer 240 or via a separate communications channel.

Each publisher 210 in FIG. 2 may comprise a server that electronically publishes a metric that changes with time. They may comprise an electronic exchange. These servers may be administered by an organization that generates the metric or by an organization that has a license to publish the metric. For example, a metric value may be a multiple-bit data value obtainable using a Universal Resource Identifier (URI), wherein the data value changes at predetermined time intervals. This then enables apparatus 220 to obtain a plurality of data values at a plurality of time points separated by the predetermined time intervals. Alternatively, a data array or table comprising a time-series of metric values may be machine-accessible at a URI or other addressable data source.

The risk analyzer 230 of FIG. 2 determines a risk category based on the first set of time-series market data MD₁. In one example, the risk category is determined at a time t, such that the data indicative of a risk category is a time-dependent variable RCₜ. The risk analyzer 230 may determine a risk category based on a plurality of data values in the first set of time-series market data MD₁, e.g. based on sampled data values at n subsequent times (i.e. n data values) representative of a predetermined time period. A risk category may be selected from a plurality of possible risk categories. Hence, RCₜ may have a value selected from a set {RC¹, RC², . . . RC¹} where i>1. A risk category may be represented by a numeric value, e.g. for use as an index, or an alphanumeric label.

The trend analyzer 240 receives, or otherwise accesses, the data indicative of a risk category, e.g. the value of time-dependent variable RCₜ. It then uses the current risk category to select an appropriate set of processing rules for the second set of time-series market data MD₂. In one example, the processing rules specify the processing of the second set of time-series market data MD₂ with one or more time-series filters. In certain cases a different set of filters are applied to the second set of time-series market data MD₂ depending on the current risk category as indicated by RC. The output of any applied filters may form the basis of the market indicator MI. In certain examples, the outputs of a plurality of applied filters are compared and a discrete value for the market indicator MI is selected based on the results of the comparison.

The trading component 250 is arranged and constructed to receive a value for the market indicator MI and determine a market action MA. In a trading context, the market action MA may be a trading action with regard to one or more tradeable object, such as a buy, sell or hold action. The one or more tradeable objects may comprise any tradeable item, including commodities, assets, shares, synthetic objects etc. The trading component 250 may be arranged to use the market action MA to instruct one or more automated trade orders at trading server 270. In this manner, the apparatus 200 of FIG. 2 may operate automatically without overt human control.

The volatility controller 260 is arranged and constructed to receive the second set of time-series market data MD₂ and apply volatility control by way of data V, which is communicated to the trading component 250. In FIG. 2, the volatility controller 260 is arranged to generate data V indicative of an order modulation, i.e. generate data that may be used by the trading component 250 to modify one or more market actions so as to realize a desired volatility measure. In certain examples, data V comprises an order recommendation based on a ratio of a determined volatility metric value for the second set of time-series market data MD₂ and a target volatility metric value for the second set of time-series market data MD₂. For example, the data V may be used by the trading component to modify one or more order quantities so as to reduce and/or increase an exposure to one or more tradeable objects.

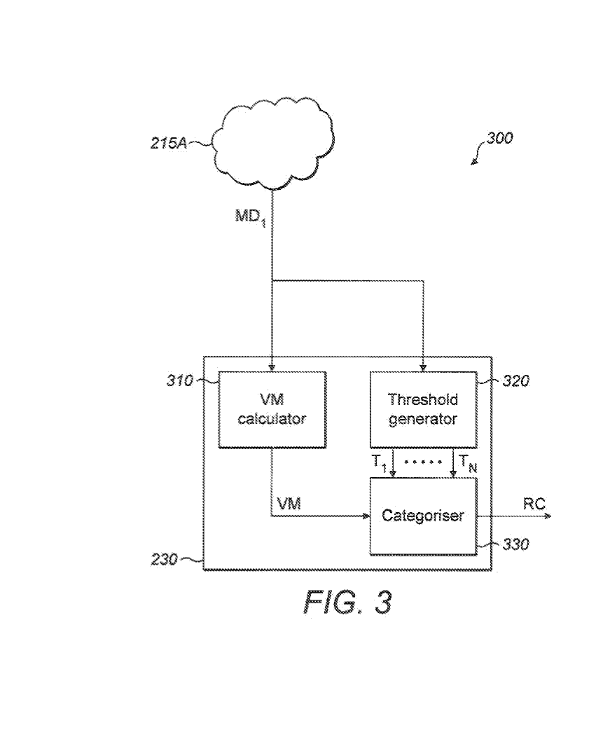

FIG. 3 shows an implementation 300 of a risk analyzer 230 according to an example. Other implementations are also possible, for example one or more other statistical methods may be used to categorise the first set of market data MD₁. The implementation 300 of FIG. 3 comprises a volatility metric (VM) calculator 310 arranged and constructed to receive the first set of time-series market data MD₁ from a data source, such as from publisher server 210A over network 215A. Responsive to the receipt of the first set of time-series market data MD₁, the volatility metric calculator 310 is arranged to calculate a volatility metric VM based on the first set of time-series market data MD₁. In certain examples, the volatility metric calculator 310 may be arranged to calculate a volatility metric VM based on a particular number of data points comprising the first set of market data MD₁, such as the last X data points from a given time t, i.e. MD1ₜ₋₀, MD1ₜ₋₁, . . . MD1_{t-X}. In one example, the volatility metric may be based on an average distance for a number of data points from a mean value, i.e. a variance or standard deviation. For example, the volatility metric may be based on a return ratio of a data point at a first time from the first set of market data and a data point at a second time preceding the first time, e.g. a natural logarithm of this ratio may be determined for a data point and an average distance for X data points from an average return ratio for the X data. The volatility metric may be scaled as required.

The implementation 300 of FIG. 3 also comprises a threshold generator 320 that is also arranged and constructed to receive the first set of time-series market data MD₁ from a data source. Again the data source may be a publisher server 210A coupled via network 215A or a separate source of market data MD₁. The threshold generator 320 is arranged to generate one or more threshold values T₁ . . . T_{N}. In the implementation 300 the one or more threshold values T₁ . . . T_{N} are generated based on the first set of time-series market data MD₁. The threshold values may be calculated based on a number of standard deviations from a mean value of the volatility metric.

The volatility metric calculator 310 and the threshold generator 320 are both communicatively coupled to a categoriser 330. The categoriser 330 is arranged and constructed to receive the volatility metric VM from the volatility metric calculator 310 and the one or more threshold values T₁ . . . T_{N} from the threshold generator 320. The categoriser 330 then uses the received data to generate data indicative of a risk category RC. In certain examples, the categoriser 330 is arranged to compare the value of the volatility metric VM to the one or more threshold values T₁ . . . T_{N} and output a risk category value based on the comparison. For example, the one or more threshold values T₁ . . . T_{N} may define a series of ranges with associated risk category values, e.g. if Tᵢ>VMₜ=>Tᵢ₊₁ then RCₜ=RCⁱ.

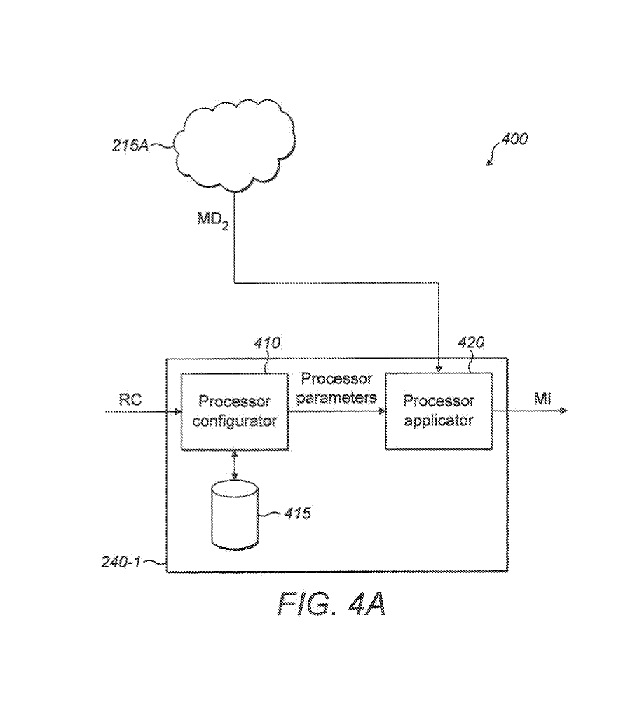

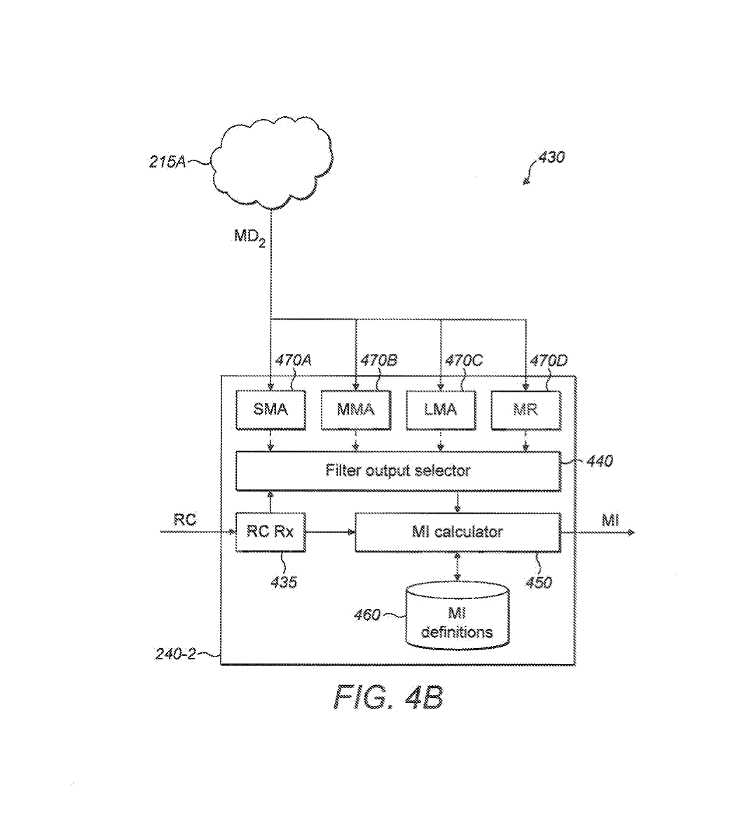

FIG. 4A shows a first implementation 400 of a trend analyzer 240 according to an example. The first implementation 400 of a trend analyzer 240 comprises a processor configuration module 410 communicatively coupled to data storage 415. The processor configuration module 410 is arranged and constructed to receive data indicative of a risk category RC from a risk analyzer 230 and to select appropriate processor configuration data from data storage 415, i.e. perform a mapping between a risk category and processor configuration data. For example, the processor configuration module 410 may be arranged to retrieve a first set of one or more configuration files from data storage if the data indicative of a risk category indicates a first risk category and may be arranged to retrieve a second set of one or more configuration flies from data storage if the data indicative of a risk category indicates a second risk category. In FIG. 4A the processor configuration data may comprise one or more processor parameters and/or one or more processing rules. The one or more processor parameters and/or one or more processing rules may define a particular ‘processor’ for the second set of time-series market data MD₂. The processors may at least comprise digital filters to be applied to the second set of time-series market data MD₂, such as infinite impulse response (IIR) and finite impulse response (FIR) filters.

In the first implementation 400 of FIG. 4A, the processor configuration data selected from the data storage 415 is communicated to a processor applicator 420, which implements one or more processors for the second set of time-series market data MD₂ based on the received processor configuration data. In one case, the processor configuration data retrieved for risk category i (RCⁱ) may comprise processor parameters that define at least one digital filter and at least one processing rule to apply to the output of the digital filter. In this case, the processor applicator 420 processing the processor parameters to implement the digital filter. The digital filter is then applied to one or more data samples that comprise the second set of time-series market data MD₂. An output of the digital filter is then subject to the processing rule. In a simple case a processing rule may be a threshold comparison, wherein a discrete value for a market indicator MI is chosen by the processor applicator 420 based on an output of the threshold comparison. In this case, a different risk category, e.g. RC^{j}, may define a different digital filter and/or a different processing rule, providing the potential for the processor applicator 420 to output a distinguished value for the market indicator based on the same set of data samples. In these examples, a digital filter may be implemented in software, hardware or a combination of the two.

FIG. 4B shows a second implementation 430 for a trend analyzer 240. In the second implementation 430, data indicative of a risk category RC is received from a risk analyzer 230 by a risk category receiver (RC Rx) 435. The risk category receiver 435 is arranged and constructed to receive the data indicative of a risk category RC and send appropriate control information based on the indicated risk category RC to a filter output selector 440 and a market indicator (MI) calculator 450. The market indicator calculator 450 is arranged and constructed to retrieve a market indicator definition from one or more market indicator (MI) definitions 460 stored in a data storage device based on the indicated risk category RC. The retrieved market indicator definition specifies one or more calculations to perform using an output received from the filter output selector 440. The market indicator calculator 450 effectively maps a risk category to a suitable set of calculations for generating a market indicator. The filter output selector 440 controls the output of one or more digital filters 470 based on an indicated risk category and sends this output to the market indicator calculator 450.

In FIG. 4B four digital filters are shown: a short-term moving average filter 470A; a medium-term moving average filter 470B; a long-term moving average filter 470C; and a mean-reversion filter 470D. In this example, the short-term moving average filter 470A comprises a filter for determining a trend over a first time period, the medium-term moving average filter 470B comprises a filter for determining a trend over a second time period and the long-term moving average filter 470C comprises a filter for determining a trend over a third time period, wherein the second time period is of longer duration than the first time period and the third time period is of longer duration than the second time period. The mean reversion filter 470D determines whether the trend or slope of the second set of time-series market data MD₂ has changed direction in a predetermined time period. Each digital filter 470 receives the second set of market data MD₂. Although not shown in FIG. 4B, in certain examples there may be one or more pre-processing steps applied to the second set of market data MD₂ before it is received by the digital filters. Whether pre-processing is applied may depend on the nature of the second set of market data MD₂.

In FIG. 4B, each digital filter 470 is capable of filtering the second set of time-series market data MD₂. In one case, all of the digital filters 470 are applied to the second set of market data MD₂ and the filter output selector 440 selects one or more of the filter outputs for sending to the market indicator calculator 450 dependent on a risk category. In another case, the filter output selector 440 activates selected ones of the digital filters 470 dependent on a risk category, e.g. for a particular risk category only two of the digital filters may be activated to filter the second set of time-series market data MD₂. In another case, filter output selector 440 may be incorporated into the market indicator calculator 450, i.e. the market indicator calculator 450 receive output from all filters but selects one or more outputs in particular to generate the market indicator MI based on a retrieved market indicator definition. In any case, the market indicator calculator 450 outputs a suitable market indicator MI value based on the supplied data indicative of a risk category RC.

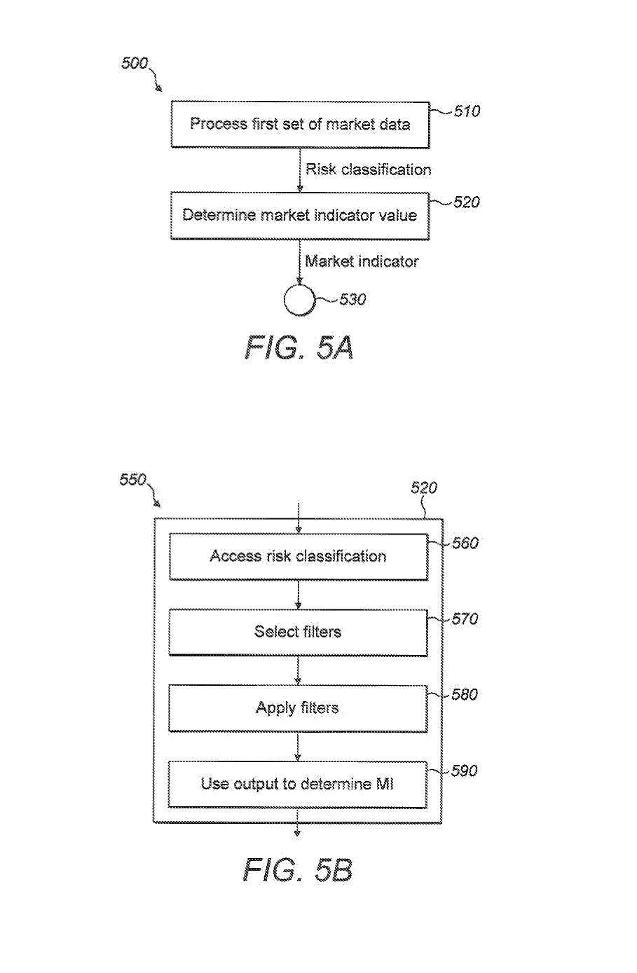

FIG. 5A is a flow diagram showing a method 500 of processing market data. The method may be applied using the apparatus of any one of FIGS. 1 to 4B. At block 510, a first set first set of time-series market data is accessed from a data source and is processed to generate data indicative of a risk category. This block may be performed by a risk analyzer such as risk analyzer 110 or 230. At block 520, a value of a market indicator is determined based on a second set of time-series market data. This block may be performed by a trend analyzer such as trend analyzer 120 or 240. At block 530, the value of the market indicator may then be used, for example to inform a market action.

FIG. 5B is a flow diagram showing a number of blocks that may implement, at least in part, block 520 of FIG. 5A. At block 560 a risk category determined in block 510 is accessed. For example, a memory register may be read, a variable may be retrieved from data storage, a message may be received over a communications network and/or a signal may be received on a signal line. This may be performed by one or more of the processor configuration module 410 and risk category receiver 435. At block 570, a number of, i.e. one or more, filters are selected based on the risk category. This may be performed by one or more of the processor configuration module 410, the filter output selector 440 and the market indicator calculator 450. These may be digital filters adapted to filter time-series data. At block 580, the one or more filters are applied to a second set of time-series market data. This may be performed by one or more of the processor applicator 420 and digital filters 470. At block 590, an output from the one or more applied filters is used to determine a value of the market indicator. This may be performed by one or more of the processor applicator 420 and the market indicator calculator 450.

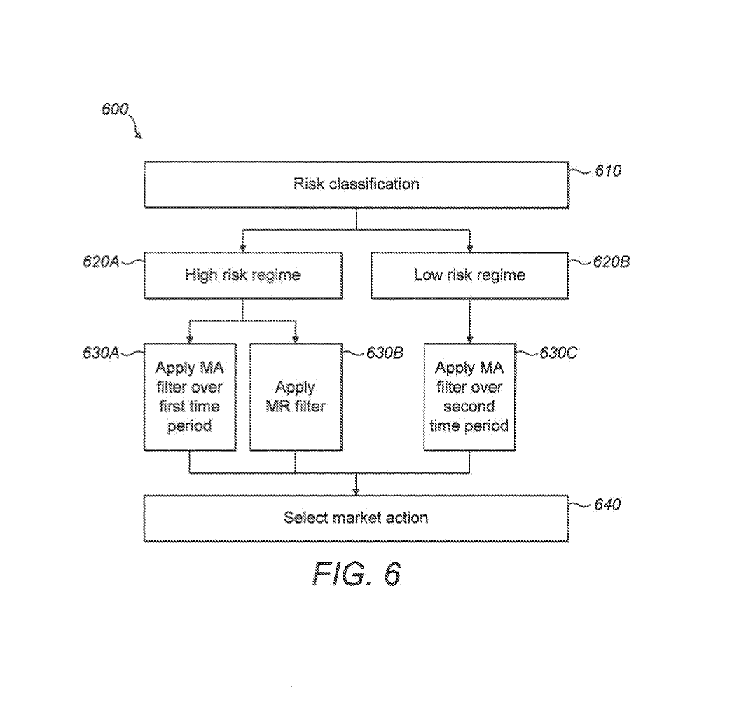

FIG. 6 is a flow diagram showing a first example of an application 600 of the method of FIG. 5A. At block 610 a risk classification is performed on a first set of time-series market data, for example at a time t. Depending on the data values of the first set of time-series market data at the time t, i.e. data values at or before time t, said market data is classified as belonging to either a high risk regime 620A or a low risk regime 620B. This application 600 may be implemented using a risk analyzer 110 or 230 that has two discrete RC values: RC¹ for the high risk regime and RC² for the low risk regime. If the first set of market data is classified as belonging to a high risk regime 620A, a first moving average (MA) filter is applied to a second set of time series data over a first time period at block 630A. A mean reversion (MR) filter is also applied in parallel to the same second set of time series data at block 630B over a second time period. The first time period is of longer duration than the second time period. If the first set of market data is classified as belonging to a low risk regime 620B, a second moving average (MA) filter is applied to the second set of time series data over a third time period at block 630C. The third time period is of longer duration than the second time period, but of shorter duration than the first time period. The filters applied in blocks 630 effectively determine trends for the second set of time-series market data. They may be implemented using a trend analyzer such as any of trend analyzers 120 and 240. At block 640 a market action is selected based on the relevant blocks 630, i.e. the output of blocks 630A and 630B for a high risk regime 620A and the output of block 630C for a low risk regime 620B. For example, in one case, if the output of blocks 630A and 630B confirm one another, e.g. are consistent, then one of a long or a short market action may be selected. If the outputs of blocks 630A and 630B conflict, e.g. are not consistent, then a hold or neutral market action may be selected. In one case, a long, short or hold market action may be selected based on the sign of the output of block 630C (e.g. positive, negative and zero respectively).

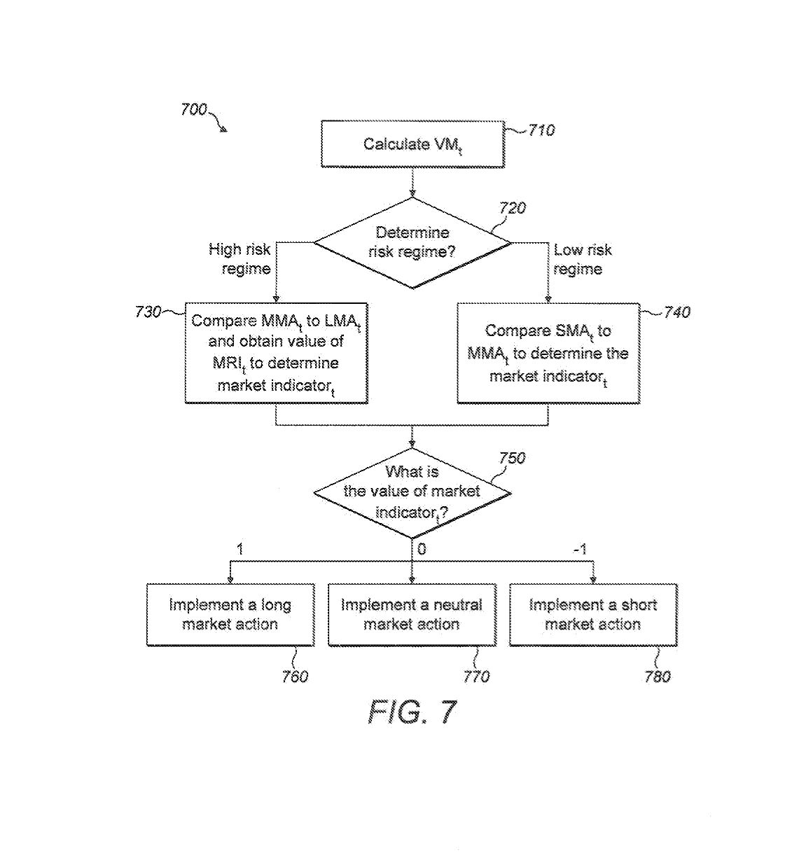

FIG. 7 is a flow diagram showing a second example of an application 700 of the method of FIG. 5A for a particular point in time t. In practice the application 700 may be repeated over a number of discrete time periods or a continuous time period. At block 710, a value for a volatility metric at time t, VMₜ, is calculated from a first set of time-series market data. This may be performed by volatility metric calculator 310 of FIG. 3. At block 720 a determination is made based on the calculated volatility metric VMₜ. For example, the volatility metric VMₜ may be compared with one or more threshold values to classify the first set of market data as indicating a high risk regime or a low risk regime.

If the first set of market data is classified as belonging to a high risk regime then three filters are applied to one or more data samples making up a second set of time-series market data at block 730. In the case of the application 700 the three filters comprise: a medium-term, moving average filter (MMA) that produces an output at time t of MMAₜ; a long-term moving average filter (LMA) that produces an output at time t of LMAₜ; and a mean-reversion filter (MR) that produces an output (or indicator I) at time t of MRIₜ. Block 730 may be representative of a filter selection action, wherein the three filters are selected from a larger set of filters. As such it may implement block 570 and/or at least one of processor configuration module 410 and filter output selector 440. The length of the moving average filter windows, and the samples to compare for the mean reversion filter, may be set out in filter parameter or configuration data that is retrieved from a data source, e.g. one of data storage 415 or 460.

At block 730 a comparison of the filter outputs is performed. In a particular example, two logic strings, which may be representative of processing rules, are applied. A first determines if i) MMAₜ is greater than or equal to LMAₜ and ii) MRIₜ equals 1, and, if so, sets a market indicator MIₜ to 1. A second determines if i) MMAₜ is less than LMAₜ and ii) MRIₜ equals−1, and, if so, sets the market indicator MIₜ to −1. If the conditions of either logic string are not met, i.e. in all other cases, a value of the market indicator at time t, MIₜ, is set to 0. This part of block 730 may be implemented by a trend analyzer 120 or 240, for example in particular one or more of processor applicator 420 and market indicator calculator 450.

If the first set of market data is classified as belonging to a low risk regime then two filters are applied to one or more data samples making up the second set of time-series market data at block 740. In the case of the application 700 the two filters comprise: a short-term moving average filter (SMA) that produces an output at time t of SMAₜ; and a medium-term moving average filter (MMA) that produces an output at time t of MMAₜ. Block 740 may be representative of a filter selection action, wherein the two filters are selected from a larger set of filters. As such it may implement block 570 and/or at least one of processor configuration module 410 and filter output selector 440. The length of the moving average filter windows may be set out in filter parameter or configuration data that is retrieved from a data source, e.g. one of data storage 415 or 460.

At block 740 a comparison of the filter outputs is performed. In a particular example, two logic strings, which may be representative of processing rules, are applied. A first determines if SMA is greater than or equal to MMAₜ and, if so, sets a market indicator MIₜ to 1. A second determines if SMAₜ is less than MMAₜ and, if so, sets the market indicator MIₜ to −1. Again, this part of block 740 may be implemented by a trend analyzer 120 or 240, for example in particular one or more of processor applicator 420 and market indicator calculator 450.

Whatever branch is taken based on the risk classification or regime, i.e. irrespective of whether block 730 or block 740 is implemented, a value of a market indicator MIₜ is generated. In the application 700 shown in FIG. 7 a determination based on the value of the market indicator MIₜ is made at block 750. This may be implemented by a trading component 250 as shown in FIG. 2. In FIG. 7, if the market indicator MIₜ has a value of 1 a long market action is implemented at block 760. This may comprise storing configuration data indicative of a long market action and/or configuring data indicative of one or more trade orders to indicate the buying of one or more tradeable objects. If the market indicator MIₜ has a value of 0 a neutral or hold market action is implemented at block 770. This may comprise storing configuration data indicative of a neutral market action and/or preventing one or more trade orders for one or more tradeable objects being sent to a trading server. If the market indicator MIₜ has a value of −1 a short market action is implemented at block 780. This may comprise storing configuration data indicative of a short market action and/or configuring data indicative of one or more trade orders to indicate the selling of one or more tradeable objects. The market actions may be taken for a particular time period, e.g., for time t until time t+1, or at a single time (e.g. time t). A “long” market action is taken in the expectation that one or more values of the second market data will rise over subsequent times. A “short” market action is taken in the expectation that one or more values of the second market data will fall over subsequent times.

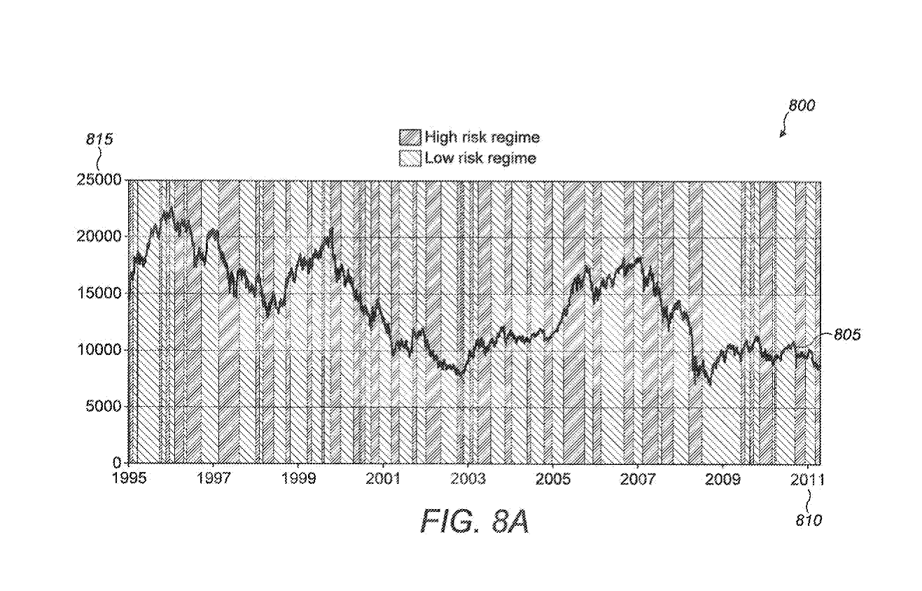

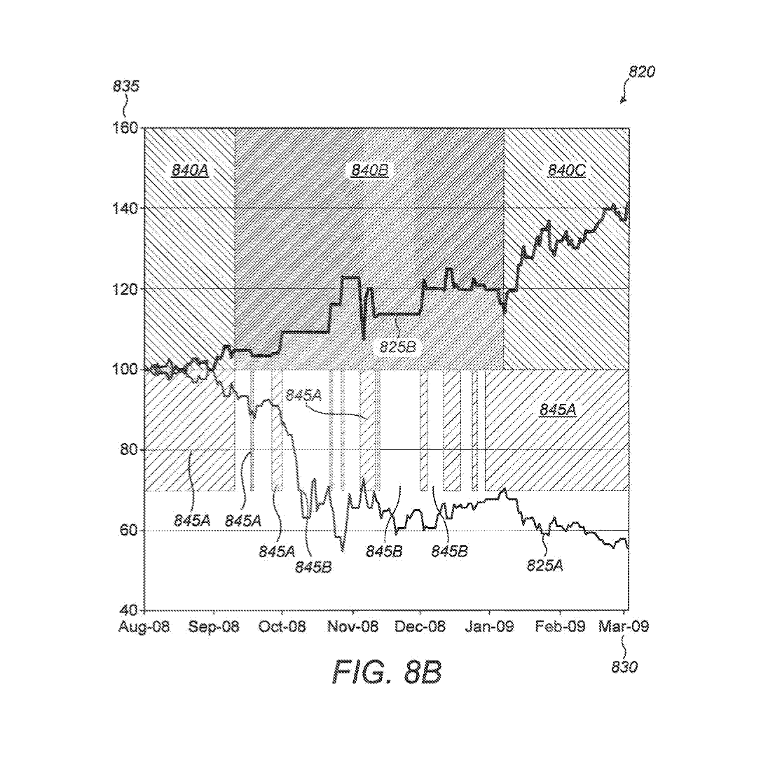

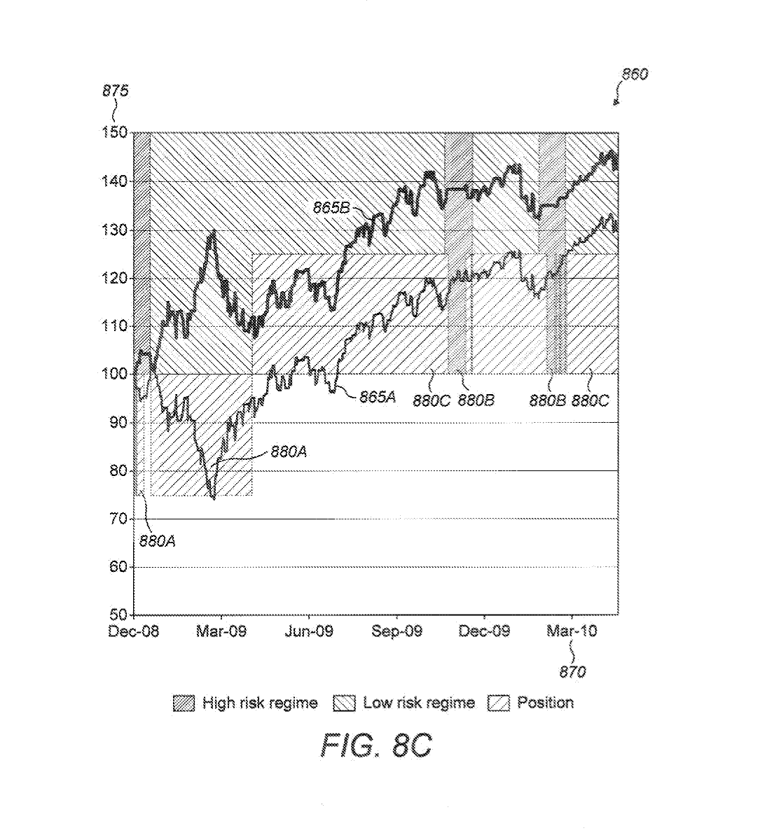

FIG. 8A shows an example 800 of a first set of time-series market data 805, together with classifications of high and low risk regimes. For sake of example, the time series data is displayed for several years, as shown on the x-axis 810. The y-axis 815 shows a data value (dv) for the time-series data, i.e. each data point will have a co-ordinate (x,y) equal to (t, dv).

FIG. 8B shows an example 820 of a second set of time-series market data 825A for a time period 830 of 8 months. The y-axis 835 shows a data value for the second set of time-series market data 825A. In FIGS. 8A, 8B and 8C the data value may represent a price of a tradeable object, an index value or a financial or commercial metric. FIG. 8B shows a first region 840A and a third region 840C where a first set of market data (not shown) was classified as low risk and a second region 840B where a first set of market data (not shown) was classified as high risk. Also shown are areas 845 that represent the value of a market indicator with respect to the second set of market data 825A. Blocks 845A below a baseline of 100 on the y-axis 835 represent a market indicator value of −1, for example as determined based on the method of FIG. 7, and blocks 845B represent a market indicator value of 0. As can be seen, there was no region where a market indicator value of 1 was determined. It can also be seen that the value of the market indicator has different characteristics for low risk regions 840A, C and high risk region 840B. For example, in high risk region 840B a neutral output for the market indicator is more likely.

FIG. 8C shows another example 860 of a second set of time-series market data 865A for a time period 870 of 13 months. The y-axis 875 shows a data value for the second set of time-series market data 865A. FIG. 8C shows a number of high risk and low risk regions as indicated by the key (e.g. a first narrow high risk region is followed by a wide low risk region that is followed by a second narrow high risk region that is followed by a medium length low risk region that is followed by a third narrow high risk region). Also shown are areas 880 that represent the value of a market indicator with respect to the second set of market data 865A. Blocks 880A below a baseline of 100 on the y-axis 875 represent a market indicator value of −1, for example as determined based on the method of FIG. 7, and blocks 880B represent a market indicator value of 0. Block 880C represents a market indicator value of 1. It again can be seen that the value of the market indicator has different characteristics for high and low risk regions.

In an extension of the described examples a value of the market indicator MI may be used to calculate an index. Such an index is shown in as market data 825B in FIG. 8B and market data 825C in FIG. 5C.

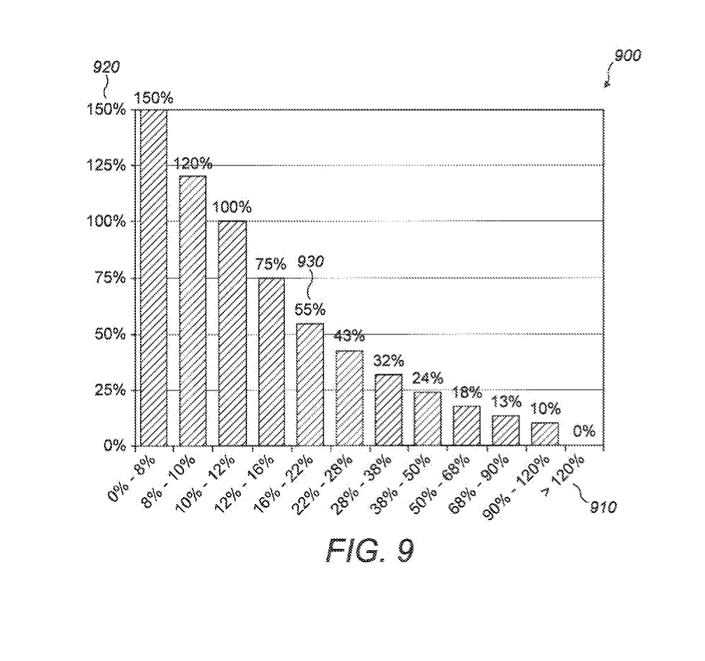

FIG. 9 shows a graphic representation 900 of a plurality of volatility bands or ranges that may be used to implement the volatility controller 260 of FIG. 2. In this case, the volatility controller 260 is arranged and constructed to determine an effective realised volatility associated with the second set of time-series market data for a predetermined time period. For example, in one implementation, the volatility controller 260 is arranged to determine an effective realised volatility at the end of a particular time t, wherein the time periods may correspond to discrete days, in which case the end of the time may be the close of business on a trading day. In this implementation the predetermined time period may be 20 days or time points, i.e. t−1, t−2 . . . to t−19. The 20 days may or may not include the current time period t. The x-axis 910 of FIG. 9 represents ranges for an effective realised volatility. After the effective realised volatility has been calculated by the volatility controller 260 based on the second set of market data (or otherwise obtained or accessed), the volatility controller 260 determines the range in which the calculated value lies. For example, a calculated effective realised volatility value of 19% would lie within band or range 16%-21% shown as 930. The values for the band or ranges may be stored in memory accessible to the volatility controller 260 and may be configurable by a user. Each band or range has an associated dynamic exposure value for a market action with respect to a tradeable object associated with the second set of market data. In the example of FIG. 9, a dynamic exposure value of 55% would be retrieved for a range of 16%-21%, i.e. for a calculated effective realised volatility value of 19%. The dynamic exposure may be communicated (or accessible) to the trading component 250 and used by the trading component 250 to modulate a market action performed for a future time period, i.e. a time period of t+1 and/or t+2. This volatility adjustment performed by the volatility controller 260 effectively determines a daily exposure adjustment based on a short term measure (e.g. 20 days) that enables a portfolio associated with a tradeabie object to remain below a target level of volatility over a medium-to-longer term time period (e.g. 1 to 2 years).

Certain described examples improve the processing of financial data. In certain examples, the first set of market data is used to determine a predicted future change in a second set of market data, so that appropriate processing that is accurate and reliable may be applied. This then enables the calculation of a robust market indicator that provides information on future changes in the second set of market data. Both an apparatus and method for transforming the first and second set of market data into useful metrics are described. The method may be completely or at least partially computer-implemented or automated. Certain examples that apply a risk classification together with intelligently-selected trend filters perform well, i.e. produce accurate metrics and operate consistently across a wide-range of data sources for the market data, including across different geographical areas and different data types. The risk classification and the subsequent select and configuration of trend filters, e.g. the selection of appropriate filter parameters to apply, produce robust results (e.g. tolerant to noise and/or rapid, dynamic changes in the market data).

A variation of certain examples will now be described. This variation may omit certain features of the previously described examples and/or add additional features not described above.

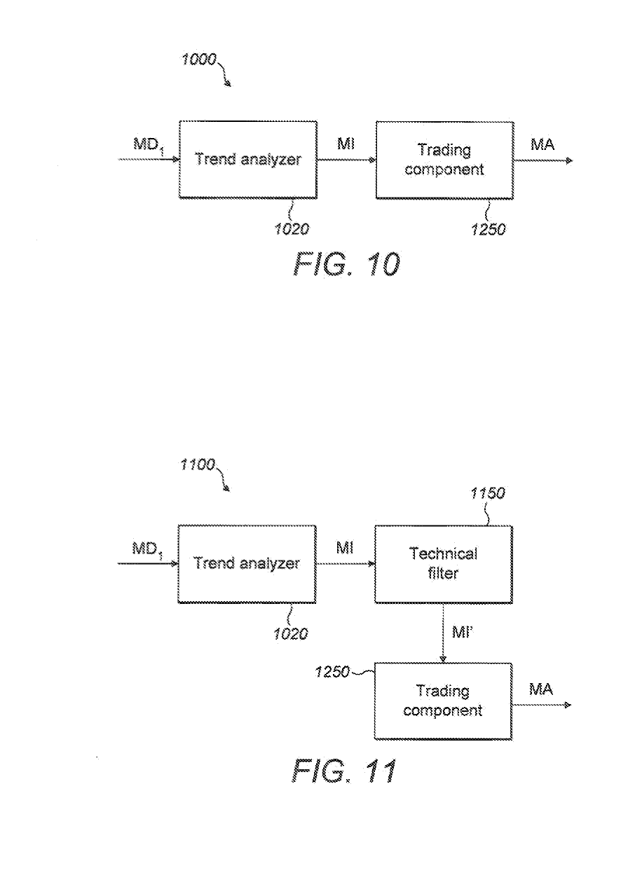

FIG. 10 shows a first example of this variation. FIG. 10 is a schematic diagram of an apparatus 1000 for processing market data that may be used as well as, or in place of the example shown in FIG. 1. The apparatus 1000 comprises a trend analyzer 1020 and a trading component 1250. The trend analyzer 1020 may be implemented in a similar manner to the trend analyzer 120 of FIG. 1, and adaptations of the trend analyzer 1020 may be applied to the trend analyzer 120 and vice versa. In other implementations the trend analyzer 1020 may be implemented in a different manner from the trend analyzer 120. The trend analyzer 1020 of FIG. 10 is arranged and constructed to receive at least a first set of market data MD₁. In certain cases the trend analyzer 1020 may receive a plurality of market data streams. The trend analyzer 110 is arranged and constructed to process received market data and generate data indicative of a market or economic indicator, referred to in this example as MI (market indicator). The market indicator MI is, in certain examples, an indicator that is representative of a future economic trend. For example, the market indicator MI may comprise a forward looking indicator, e.g. representative of a time t in the future, where t may be a week, month or year into the future as required. In certain examples, the market indicator MI is output as a classification, for example a classification that a future economic trend is going to be positive or negative. In this case, the market indicator MI has two possible values; however, in more complex examples the market indicator may represent one of a plurality of trend classifications.

The trend analyzer 1020 of FIG. 10 is communicatively coupled to a trading component 1250. The trading component 1250 may be fully automated and/or under control of a user, for example via a graphical user interface of a computing device. The trading component is arranged and constructed to receive the market indicator MI from the trend analyzer 1020. The trading component 1250 is further arranged and constructed to process the market indicator MI and output data indicative of a market action MA based on the market indicator MI. For example, in one case, a market indicator MI may have either a positive or negative value indicative of a positive or negative market trend. If the trading component 1250 detects a positive market indicator MI received from the trend analyzer 1020, it may be arranged to output a market action MA indicative of a long position in equities. On the other hand, if the trading component 1250 detects a positive market indicator MI received from the trend analyzer 1020, it may be arranged to output a market action MA indicative of a long position in bonds. The market actions of the trading component 1250 may be configurable by a user, for example the trading component 1250 may comprise a data structure that implements a mapping from a received market indicator MI to a market action MA. In this case, entries in the data structure that set out the mapping for each market indicator value may be configurable through a local or remote user interface. In certain cases, the market action MA may comprise a data signal arranged to initiate a transaction at a remote trading server.

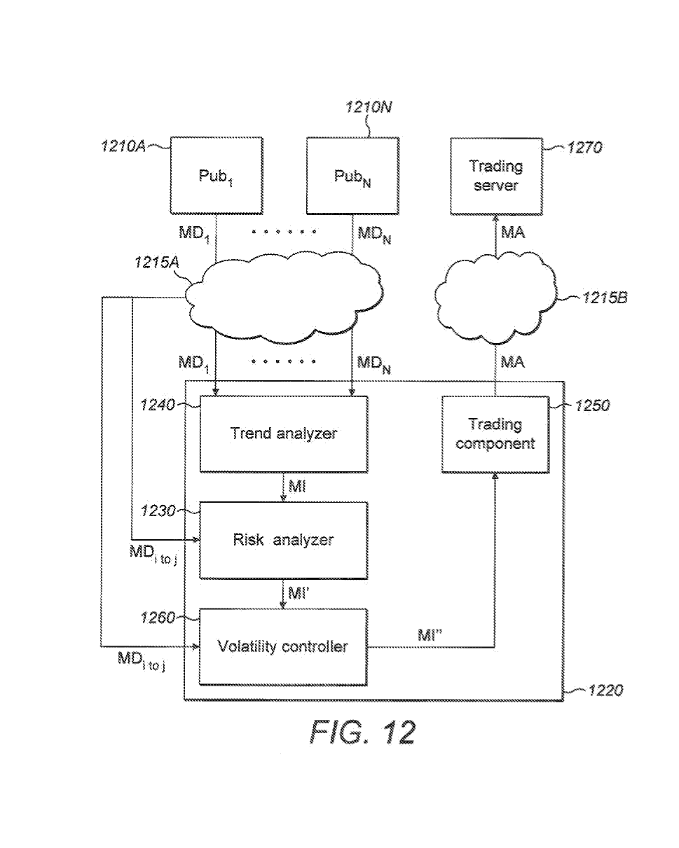

FIG. 11 shows a second example 1100 of the variation. In this example a technical filter 1150 is communicatively coupled between a trend analyzer 1020 and a trading component 1250. The technical filter 1150 receives an initial market indicator MI from the trend analyzer 1020, performs a filtering operation based on the received data and outputs a filtered market indicator MI′ for supply to the trading component 1250.

In certain cases the data indicative of the market indicator MI may comprise an allocation of tradeable objects. In a simple case, this may be data indicative of a particular percentage of a first tradeable object and data indicative of a particular percentage of a second tradeable object, the two percentages summing to 100%. In more complex cases this may comprise allocations for a plurality of tradable objects. In this case, the technical filter 1150 is arranged to receive an initial allocation and filter it to produce a revised allocation. This filtering may be seen as a fine-tuning of the initial allocation. In certain cases, not shown in FIG. 11, the technical filter 1150 may receive one or more items of data, such as one or more streams of market data MD as described above. In these cases, the technical filter 1150 is arranged to filter the initial allocation based on the values of the received data. Further detail of this process is described with regard to FIG. 12 below.

FIG. 12 is a schematic diagram of a system comprising a third example 1220 of the variation. The example apparatus 1220 may comprise a computing device communicatively coupled to one or more networks. The apparatus 1220 comprises a trend analyzer 1240, a risk analyzer 1230, a volatility controller 1260, and a trading component 1250. The trend analyzer 1240 may comprise the trend analyzer 1020 of FIG. 10. The trading component 1250 is shown as the same trading component as FIG. 10 but in certain cases may comprise a different trading component. The risk analyzer 1230 and the volatility controller 1260 may collectively form at least a portion of the technical filter 1150 of FIG. 11.

In FIG. 12 the apparatus 1220 is communicatively coupled to a plurality of publishers 1210A to 1210N. In other examples, these may comprise one or more publishers. These publishers 1210 may be of a similar construction to those described in relation to FIG. 2. The apparatus 1220 is further communicatively coupled to a trading server 1270. The publishers 1210 and trading server 1270 do not form part of the example apparatus 1220 but form part of a wider system for communicating with the apparatus. Each of the trend analyzer 1240, the risk analyzer 1230 and the volatility controller 1260 are arranged to receive one or more data streams from the plurality of publishers 1210A to 1210N. The one or more data streams received by any particular component need not be the same as one or more data streams received by another component, for example risk analyzer 1230 may receive a different set of streams from one or more of the trend analyzer 1240 and the volatility controller 1260. However, in certain cases a common set of data streams may be received by two or more components. In FIG. 12 the data streams comprise time-series market data; however, in other implementations any other type of data may be provided, e.g. single variable or tuples.

In the example of FIG. 12, the trend analyzer 1240 receives one or more data streams MD₁ to MD_{N}. It is then arranged to process the one or more data streams to produce a market indicator. This may be performed as described above in relation to FIGS. 10 and 11. The market indicator MI in this example comprises a market allocation, i.e. an allocation of tradeable objects. The market indicator MI is passed from the trend analyzer 1240 to the risk analyzer 1230.

The risk analyzer 1230 is arranged to adjust, i.e. filter, the allocation of tradeable objects based on one or more of a risk classification and a detection of a risk event. In certain cases, the risk analyzer 1230 is arranged to determine a risk classification and/or detect a risk event; in other cases the risk analyzer 1230 may receive data indicative of a risk classification and/or a risk event from a coupled third-party system. In the case that the risk analyzer 1230 is arranged to determine a risk classification, the risk analyzer 1230 may comprise similar features to one or more of the risk analyzers 110, 230 and 300 of FIGS. 1 to 3. For example, the risk analyzer 1230 may be arranged to determine a risk category based on one or more sets of time-series market data MD_{i to j} and then use this risk category to select a predefined or formulaic adjustment of the allocation in the market indicator, i.e. to produce a revised market indicator MI′ including the revised market allocation. In certain cases, the risk analyzer 1230 may also comprise the features of one or more of the trend analyzers 120, 240, 400 and 430 of FIGS. 1, 2, 4A and 48. For example, the market indicator generated as the output of one or more of said trend analyzers 120, 240, 400 and 430 of FIGS. 1, 2, 4A and 4B may be used to modulate the allocation of the trend analyzer 1240.

In certain cases where the risk classifier 1230 is arranged to detect a risk event, the risk classifier 1230 may monitor one or more data streams to look for one or more triggers. A risk event may be triggered by a pattern of data values that indicates an abnormal spike in risk. For example, with time-series market data, a risk event may be detected if: 1) the data indicates a cumulative draw down of equity that is more that a predetermined number of standard deviations away from a mean value, such as a rolling 1-year daily return of equity; and 2) a smoothed absolute change of equity for a time period, such as a day, is more than a predetermined number of standard deviations above a mean value, such as a rolling 1-year distribution of such change. Once a risk event is detected it may be used to instruct a predetermined modulation or filtering of the market allocation to produce a revised market indicator MI′ including the revised market allocation. An indication of a risk event may be stored and may be used to modify the market allocation until a further set of conditions are detected. For example, a risk event may stay active until either the conditions 1) and 2) are no longer met or there is a particular change in the initial market indicator MI and/or a risk classification.

The volatility controller 1260 is arranged to receive one or more data streams, in the case of FIG. 12—one or more sets of time-series market data MD_{i to j}—and produce a further revised market indicator MI″ including a further revised market allocation. The volatility controller 1260 may be similar to the volatility controller 260 described in relation to FIG. 2 and/or FIG. 9. For example, similar to volatility controller 260, the volatility controller 1260 of FIG. 12 may be arranged to generate data indicative of an order modulation, i.e. data that is used by volatility controller 1260 to modify the revised market allocation that forms part of the revised market indicator MI′ so as to realize a desired volatility measure. For example, the volatility controller 1260 may be used to modify a revised market allocation so as to reduce and/or increase an exposure to one or more tradeable objects. For example, exposure, i.e. a percentage allocation, of a particular tradeable object may be increased when a realised volatility of market data associated with said tradeable object is low. On the other hand, exposure, i.e. a percentage allocation, may be reduced when the realised volatility of market data associated with said tradeabie object increases.

In the example of FIG. 12, a market allocation is generated by the trend analyzer 1240 and then is successively modified by the risk analyzer 1230 and the volatility controller 1260. The volatility controller 260 thus sends data indicative of a final market allocation as part of market indicator MI″ to the trading component 1250. However, in other examples the trading component 1250 may receive data signals from one or more of the trend analyzer 1240, the risk analyzer 1230 and the volatility, controller 1260 and use this data to generate a market allocation at the trading component 1250. This latter case is similar to that applied in the example of FIG. 2.

The trading component 1250 communicates a market action MA to the trading server 2270 over a second network 1215B. This may be performed in a similar manner to the apparatus of FIG. 2. The market action MA may be used to initiate a trade order for one or more tradeable objects hosted on one or more electronic exchanges based on a final market allocation.

An example of the operation of the apparatus 1220 of FIG. 12 will now be described. In this example, the values used are selected to aid explanation of the functions performed and are not limiting. In other implementations other values, mappings and modification functions may be applied. In this example, the trend analyzer 1240 generates a market indicator MI that comprises a market allocation of a 100% long position in a first tradeable object and a 0% long position in a second tradeable object. The tradeable objects may comprise a basket of shares represented by an index or a financial instrument represented by an index. A long position means that there will be notional exposure to the relevant tradeable object in the expectation that, for example, the price level of shares in said tradeable object will rise. This market indicator MI comprising the market allocation is passed to the risk analyzer 1230. The risk analyzer 1230 then determines that a set of market data MD_{i to j} is to be classified as ‘high risk’. The risk analyzer 1230 retrieves an internal mapping from the category ‘high risk’ to a modification function for the market allocation. In this example, the modification function is to diversify the market allocation by 10%, i.e. the market allocation is revised by the risk analyzer 1230 to be a 90% long position in the first tradeable object and a 10% long position in the second tradeable object. A revised market indicator MI′ comprising the modified market allocation is then passed to the volatility controller 1260. The volatility controller 1260 helps further improve the risk return profile by effective downside risk management. In this example, an effective realised volatility is calculated. This calculation may be based on market data MD_{i to j} relating to one or more of the first and second tradeable objects. In the present example, an effective realised volatility is calculated for the first tradeable object and this is found to be 13%. If it is assumed for this example that the volatility controller 1260 uses the mapping set out in FIG. 9, then this returns a dynamic exposure value of 75%. Hence, the volatility controller 1260 modulates the market allocation received from the risk analyzer 1230 to produce a revised allocation of 67.5% for the first tradeable object (90% multiplied by 75%). A similar process may also be performed for the second tradeable object. The final market allocation may be scaled to sum to 100% or a sum less or greater than 100% may respectively represent a reduced or increased net exposure. The final market allocation is then sent from the volatility controller 1260 to the trading component 1250 with the market indicator MI″. The trading component 1250 then builds one or more orders for said tradeable objects based on the final market allocation. These one or more orders may be sent to the trading server 1270 as a market action MA.

In certain cases the trend analyzer 1240 is arranged to process multiple data streams to produce a market indicator MI. For example, for a particular geographical location, state and/or industry, amongst others, the trend analyzer 1240 may receive data indicative of: inventory circulation in advance; a consumer expectation index; machinery orders received; import of capital goods; construction orders received; net barter terms of trade; opening-to-application ratio; stock price index; total liquidity; and interest rate spread 3-year treasury bonds less call rate. The trend analyzer 1240 may be arranged to receive data and/or sample one or more data streams at periodic intervals. For example, the indicators set out above may be sampled on a monthly basis. They may further be interpolated and/or sampled so as to be combined in a time series index, e.g. monthly and daily published data may be appropriately combined to produce a daily index. In certain examples, a rate of change for a particular time period of the time series index may be used by the trend analyzer 1240 to generate a market indicator MI classification. One possible classification may be based on a monthly rate of change of a time series index generated from the indicators set out above: if said rate of change is positive a positive market indicator MI may be output (e.g. MI=‘1’ or ‘+’) and if said rate of change is negative a negative market indicator MI may be output (e.g. MI=‘0’ or ‘-’). The market indicator MI may be mapped to a market allocation by either the trend analyzer 1240 itself or the trading component 1250.

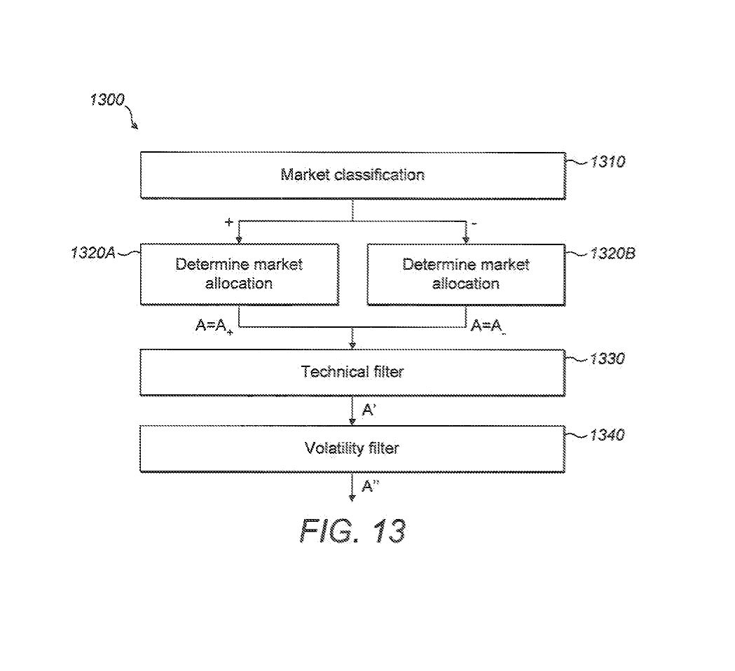

FIG. 13 is a flow chart showing a method 1300 of processing market data according to a variation. This method 1300 may be applied by any one of the apparatus 1000, 1100 and 1220 shown in FIGS. 10 to 12. At block 1310 a market classification is performed based on one or more data streams. The one or more data streams may comprise one or more sets of time-series market data. The market classification applies a classification function and outputs a classification value. The classification function may be a statistical or machine learning function. In FIG. 13, block 1310 outputs one of two possible classification values: ‘+’, i.e. a positive classification and ‘−’, i.e. a negative classification. The classification value may be a classification of a future economic trend. At blocks 1320A and 1320B a market allocation A is determined based on the output classification value. In block 1320A a first market allocation A₊ is determined based on a positive classification value (i.e. A=A₊) and in block 1320B a second market allocation A₋ is determined based on a negative classification value (i.e. A=A₋). Only one of blocks 1320A and 1320B may be applied in any one pass of the method. At block 1330 a technical filter is applied to the market allocation A to generate an enhanced market allocation A′. The technical filter may apply one or more of a trend-following approach based on a risk classification and a risk-event approach based on the detection of a risk event. At block 1340 a volatility filter is applied to the enhanced market allocation A′ to generate a risk adjusted allocation A″. In certain cases, the volatility filter 1340 may not be applied. The market allocation output from the method 1300, i.e. A″ (or in certain cases A′), may be used by a trading component to generate one or more order for tradeable objects.

In a certain case, the technical filter may alternatively be applied as an overlay before the market allocation blocks 1320. In this case, a risk overlay indicator may be calculated by the technical filter. A risk overlay indicator indicates that a risk event has occurred in a predefined time period at a particular time t_{RE}. The risk event may be a risk event as described above or may be detected according to another set of criteria based on one or more data streams. In one case, for a predetermined time period following detection of a risk event, e.g. a predetermined time period following t_{RE}, a default market allocation may be selected such as a 100% long position in bonds.

Certain examples of the variation described above provide a data processing system that enables automated market decisions based on signal processing. The signal processing operates on one or more data streams, such as time-series data, to generate a forward looking economic signal. This signal may be used, for example, to automate a switch into and out of tradeable objects representing equities, bonds, cash, short bonds, currencies, commodities or other asset classes. In certain cases, similar to the application of the examples of FIGS. 1 to 9 on two sets of market data, a trend analyzer operates on one or more data streams that comprise data associated with, but not directly representing, one or more tradeable objects. For example, the trend analyzer may be applied to time-series data representing indices from a country's stock market and an output market allocation may be applied to commodities.

Any of the examples described above, for example in relation to any of FIGS. 1 to 13, may be applied to time-series market data representing any suitable asset category and the generated market indicators and market actions may be taken with respect to the same or a different asset class or series of classes. For example, the time series market data may represent one or more indices of a specific country's stock market and one on r more market indicators may be generated to direct market actions for actively managed funds, commodities such as gold or oil, and/or foreign exchange transactions.

The components described herein and shown in the figures may be implemented using electronic data-processing apparatus. For example, apparatus 220 and/or 1220 may be implemented by a computer system configured comprising at least one or more central processing units (CPUs), memory and an input/output interface. The data and the programs for controlling the apparatus are stored in memory and implemented by the one or more CPUs. The input/output interface connects the computer system to one or more network systems. As well as, or instead of, one or more computer systems, the components described herein may be implemented by suitably programmed, configured and/or constructed electronic devices such as Field Programmable Gate Arrays (FPGAs), system-on-chip (SOC) components and digital filters.

According to certain described examples, an apparatus for processing time-series market data comprises a risk analyzer arranged to access a first set of time-series market data from a data source and to process said first set of time-series market data to generate data indicative of a risk category and a trend analyzer arranged to access said data indicative of a risk category determined by the risk analyzer and to output a value of a market indicator based on a second set of time-series market data, the trend analyzer being arranged to determine the value of the market indicator using an output of a set of filters, the set of filters being selected by the trend analyzer according to said data indicative of a risk category.

In these examples, data indicative of the value of the market indicator is more representative of an underlying trend. It is also more stable even when the sets of market data are chaotic and complex. It is thus better suited for use by automated trading systems.

In certain cases, the apparatus comprises a trading component arranged to generate data indicative of a market action with respect to the second set of time-series market data based on the value of the market indicator output by trend analyzer.

In certain cases, the risk analyzer is arranged to categorize the first set of time-series market data into one of at least a first risk category and a second risk category and the trend analyzer is arranged to use an output of a first set of filters to determine the value of the market indicator if said data indicative of a risk category indicates the first risk category and to use an output of a second set of filters to determine the value of the market indicator if said data indicative of a risk category indicates the second risk category. The second set of filters may comprise a mean-reversion filter and the trend analyzer may be arranged to at least compare the output of a plurality of applied filters to determine a value of the market indicator.

This results in fewer errors as filters that are suitable for a particular form of input data may be selected based on a classification of data characteristics. For example, a particular set of filters may not produce a reliable output for data that exhibits large fluctuations. Hence, where data is classified as having a particular risk category, this may indicate that it exhibits such fluctuations and a more suitable set of filters may be selected.

In certain cases, the first set of filters comprises at least a filter for determining a trend over a first time period and a filter for determining a trend over a second time period, the second time period being of longer duration than the first time period, and wherein the second set of filters comprises at least a filter for determining a trend over the second time period and a filter for determining a trend over a third time period, the third time period being of longer duration than the second time period. The first set of time-series market data may comprise data values over time based on at least price data for at least one tradeable object, and the risk analyzer may be arranged to generate data indicative of a risk category based on at least one volatility metric derived from said data values over time.

In certain cases, the trend analyzer is arranged to at least compare the output of a plurality of applied filters to determine a value of the market indicator. Responsive to said at least one volatility metric being greater than a first threshold, the risk analyzer may be arranged to generate data indicative of a first risk category and responsive to said at least one volatility metric being less than a second threshold, the risk analyzer may be arranged to generate data indicative of a second risk category. One or more of the first and second thresholds may be based on a statistical metric for a predefined time period calculated from the first set of time-series market data.

In certain cases, the apparatus comprises a volatility controller in communication with the trading component, the volatility controller being arranged to generate an order recommendation based on a ratio of a determined volatility metric value for the second set of time-series market data and a target volatility metric value for the second set of time-series market data.

The volatility controller enables a market action to be modified in times of high volatility to prevent automated trading tools from being over exposure, i.e. from requesting transactions for a large number of tradeable object where the characteristics of the tradeable object and liable to change in the short future time period.

In certain described examples, a method of processing market data comprises processing a first set of time-series market data accessed from a data source to generate data indicative of a risk category and determining a value of a market indicator based on a second set of time-series market data. The determining in turn comprises accessing said data indicative of a risk category, selecting a set of filters according to said data indicative of a risk category, applying at least the selected set of filters to the second set of time-series market data and determining the value of the market indicator using an output of said selected set of filters.

In certain cases, a method comprises generating data indicative of a market action with respect to the second set of time-series market data based on the determined value of the market indicator. The data indicative of a market action may indicate one of a long position, a short position and a hold position. The generating may comprise generating an order recommendation based on a ratio of a determined volatility metric value for the second set of time-series market data and a target volatility metric value for the second set of time-series market data.

In certain cases, processing a first set of time-series market data comprises generating data indicative of a risk category based on at least one volatility metric derived from said first set of time-series market data. The processing may also comprise categorizing the first set of time-series market data into one of at least a first risk category and a second risk category and selecting a set of filters according to said data indicative of a risk category may comprise selecting a first set of filters if said data indicative of a risk category indicates the first risk category and selecting a second set of filters if said data indicative of a risk category indicates the second risk category.

In certain cases, generating data indicative of a risk category based on at least one volatility metric comprises generating data indicative of a first risk category if said at least one volatility metric is greater than a first threshold, and generating data indicative of a second risk category if said at least one volatility metric is less than a second threshold.

In certain cases, a method comprises generating at least one statistical metric for the first set of time-series market data over a predefined time period calculated and setting the at least one statistical metric as a respective one of at least one of the first threshold and the second threshold.

In certain cases, the first set of filters comprises at least a filter for determining a trend over a first time period and a filter for determining a trend over a second time period, the second time period being of longer duration than the first time period, and wherein the second set of filters comprises at least a filter for determining a trend over the second time period, a filter for determining a trend over a third time period, the third time period being of longer duration than the second time period, and a mean-reversion filter and determining the value of the market indicator using an output of said selected set of filters comprises comparing an output of a plurality of applied fitters to determine a value of the market indicator.

In certain described variations, an apparatus for generating data indicative of a market allocation for one or more tradeable objects comprises a trend analyzer arranged to receive a first set of one or more data streams comprising market data and to generate data indicative of a value of a market indicator, the market indicator representing a predicted future trend and being used to determine data indicative of a market allocation for one or more tradeable objects and a technical filter arranged to receive a second set of one or more data streams comprising market data and to apply at least a risk classification to said second set of one or more data streams to generate one or more signals for use in modulating said data indicative of a market allocation for the one or more tradeable objects, the risk classification comprising the determination of a risk category, wherein the apparatus is arranged to use the output of the trend analyzer and the output of the technical filter to output data indicative of a modulated market allocation for the one or more tradeable objects.

Apparatus such as this is suitable for automatically handling risky assets while minimizing risk. It does this by automatically switching from a risky asset to a less risky asset based on a value of a market indicator calculated based on one or more data streams.

In certain cases, a technical filter is arranged to detect a risk event and wherein data indicative of a risk event in a predetermined time period is used to modulate said data indicative of a market allocation for the one or more tradeable objects.

In certain cases, a trading component is arranged to generate data indicative of one or more market actions based on the modulated market allocation for the one or more tradeable objects.

In certain cases, a volatility controller arranged to receive a third set of one or more data streams comprising market data and to generate one or more signals for use in further modulating said modulated market allocation for the one or more tradeable objects based on a determined volatility metric value for the third set of one or more data streams.

In certain described variations, a method of generating data indicative of a market allocation for one or more tradeable objects comprises processing a first set of one or more data streams comprising market data to generate data indicative of a value of a market indicator, the market indicator representing a predicted future trend and being used to determine data indicative of a market allocation for one or more tradeable objects, processing a second set of one or more data streams comprising market data, including applying at least a risk classification to said second set of one or more data streams to generate one or more signals for use in modulating said data indicative of a market allocation for the one or more tradeabie objects, the risk classification comprising the determination of a risk category and outputting data indicative of a modulated market allocation for the one or more tradeable objects based on the processing of the first and second sets of one or more data streams. A non-transitory computer-readable storage medium comprising a set of computer-readable instructions stored thereon, may be used which, when executed by a processing system, cause the processing system to perform a method according to these described variations.

Although at least some aspects of the examples described herein with reference to the drawings comprise computer processes performed in processing systems or processors, the disclosure also extends to computer programs, particularly computer programs on or in a carrier, adapted for putting the disclosure into practice. The program may be in the form of non-transitory source code, object code, a code intermediate source and object code such as in partially compiled form, or in any other non-transitory form suitable for use in the implementation of processes according to the disclosure. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc. In use, the computer program may be loaded from the carrier as code and loaded into memory for processing by one or more processors in a computing system. References to “data” and/or “signals” may correspond to analogue or digital representations of information, for each in the form of binary values stored in suitable memory arrays and/or storage devices and accessible by the components described herein.

The above examples are to be understood as illustrative examples. Further examples are envisaged. Although the specification may refer to “an one”, “one”, or “some” example(s) in several locations, this does not necessarily mean that each such reference is to the same example(s), or that the feature only applies to a single example. Single features of different embodiments may also be combined to provide other examples. Furthermore, words “comprising” and “including” should be understood as not limiting the described examples to consist of only those features that have been mentioned and such examples may contain also features/structures that have not been specifically mentioned. For example, it is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the disclosure, which is defined in the accompanying claims.

What is claimed is:

1. Apparatus for processing time-series market data comprising:
a risk analyzer arranged to access a first set of time-series market data from a data source and to process said first set of time-series market data to generate data indicative of a risk category; and
a trend analyzer arranged to access said data indicative of a risk category determined by the risk analyzer and to output a value of a market indicator based on a second set of time-series market data, the trend analyzer being arranged to determine the value of the market indicator using an output of a set of filters, the set of filters being selected by the trend analyzer according to said data indicative of a risk category.

2. Apparatus according to claim 1, comprising:
a trading component arranged to generate data indicative of a market action with respect to the second set of time-series market data based on the value of the market indicator output by trend analyzer.

3. Apparatus according to claim 1, wherein the risk analyzer is arranged to categorize the first set of time-series market data into one of at least a first risk category and a second risk category and the trend analyzer is arranged to use an output of a first set of filters to determine the value of the market indicator if said data indicative of a risk category indicates the first risk category and to use an output of a second set of filters to determine the value of the market indicator if said data indicative of a risk category indicates the second risk category.

4. Apparatus according to claim 3, wherein the first set of filters comprises at least a filter for determining a trend over a first time period and a filter for determining a trend over a second time period, the second time period being of longer duration than the first time period, and wherein the second set of filters comprises at least a filter for determining a trend over the second time period and a filter for determining a trend over a third time period, the third time period being of longer duration than the second time period.

5. Apparatus according to claim 4, wherein the trend analyzer is arranged to at least compare the output of a plurality of applied filters to determine a value of the market indicator.

6. Apparatus according to claim 4, wherein the second set of filters comprises a mean-reversion filter and the trend analyzer is arranged to at least compare the output of a plurality of applied filters to determine a value of the market indicator.

7. Apparatus according to claim 1, wherein the first set of time-series market data comprises data values over time based on at least price data for at least one tradeable object, the risk analyzer being arranged to generate data indicative of a risk category based on at least one volatility metric derived from said data values over time.

8. Apparatus according to claim 7, wherein:
responsive to said at least one volatility metric being greater than a first threshold, the risk analyzer is arranged to generate data indicative of a first risk category, and
responsive to said at least one volatility metric being less than a second threshold, the risk analyzer is arranged to generate data indicative of a second risk category.

9. Apparatus according to claim 8, wherein one or more of the first and second thresholds are based on a statistical metric for a predefined time period calculated from the first set of time-series market data.

10. Apparatus according to claim 2, comprising:
a volatility controller in communication with the trading component, the volatility controller being arranged to generate an order recommendation based on a ratio of a determined volatility metric value for the second set of time-series market data and a target volatility metric value for the second set of time-series market data.

11. A method of processing market data comprising:
processing a first set of time-series market data accessed from a data source to generate data indicative of a risk category; and
determining a value of a market indicator based on a second set of time-series market data, said determining comprising:
accessing said data indicative of a risk category;
selecting a set of filters according to said data indicative of a risk category;
applying at least the selected set of filters to the second set of time-series market data; and
determining the value of the market indicator using an output of said selected set of filters.

12. A method according to claim 11, comprising:
generating data indicative of a market action with respect to the second set of time-series market data based on the determined value of the market indicator.

13. A method according to claim 12, wherein the data indicative of a market action indicates one of a long position, a short position and a hold position.

14. A method according to claim 11, wherein processing a first set of time-series market data comprises:
generating data indicative of a risk category based on at least one volatility metric derived from said first set of time-series market data.

15. A method according to claim 11, wherein generating data indicative of a risk category based on at least one volatility metric comprises:
generating data indicative of a first risk category if said at least one volatility metric is greater than a first threshold, and
generating data indicative of a second risk category if said at least one volatility metric is less than a second threshold.

16. A method according to claim 15, comprising:
generating at least one statistical metric for the first set of time-series market data over a predefined time period calculated; and
setting the at least one statistical metric as a respective one of at least one of the first threshold and the second threshold.

17. A method according to claim 11, wherein processing a first set of time-series market data comprises:
categorizing the first set of time-series market data into one of at least a first risk category and a second risk category;
and selecting a set of filters according to said data indicative of a risk category comprises:
selecting a first set of filters if said data indicative of a risk category indicates the first risk category; and
selecting a second set of filters if said data indicative of a risk category indicates the second risk category.

18. A method according to claim 17, wherein:
the first set of filters comprises at least a filter for determining a trend over a first time period and a filter for determining a trend over a second time period, the second time period being of longer duration than the first time period, and wherein the second set of filters comprises at least a filter for determining a trend over the second time period, a filter for determining a trend over a third time period, the third time period being of longer duration than the second time period, and a mean-reversion filter; and
determining the value of the market indicator using an output of said selected set of filters comprises comparing an output of a plurality of applied filters to determine a value of the market indicator.

19. A method according to claim 12, wherein generating data indicative of a market action comprises generating an order recommendation based on a ratio of a determined volatility metric value for the second set of time-series market data and a target volatility metric value for the second set of time-series market data.

20. A non-transitory computer-readable storage medium comprising a set of computer-readable instructions stored thereon, which, when executed by a processing system, cause the processing system to perform a method of processing market data, the method comprising:
processing a first set of time-series market data accessed from a data source to generate data indicative of a risk category; and
determining a value of a market indicator based on a second set of time-series market data, said determining comprising:
accessing said data indicative of a risk category;
selecting a set of filters according to said data indicative of a risk category; and
applying at least the selected set of filters to the second set of time-series market data; and
determining the value of the market indicator using an output of said selected set of filters.

21. Apparatus for generating data indicative of a market allocation for one or more tradeable objects comprising:
a trend analyzer arranged to receive a first set of one or more data streams comprising market data and to generate data indicative of a value of a market indicator, the market indicator representing a predicted future trend and being used to determine data indicative of a market allocation for one or more tradeable objects; and
a technical filter arranged to receive a second set of one or more data streams comprising market data and to apply at least a risk classification to said second set of one or more data streams to generate one or more signals for use in modulating said data indicative of a market allocation for the one or more tradeable objects, the risk classification comprising the determination of a risk category,
wherein the apparatus is arranged to use the output of the trend analyzer and the output of the technical filter to output data indicative of a modulated market allocation for the one or more tradeable objects.

22. Apparatus according to claim 21, wherein the technical filter is arranged to detect a risk event and wherein data indicative of a risk event in a predetermined time period is used to modulate said data indicative of a market allocation for the one or more tradeable objects.

23. Apparatus according to claim 21, comprising:
a trading component arranged to generate data indicative of one or more market actions based on the modulated market allocation for the one or more tradeable objects.

24. Apparatus according to claim 21, comprising:
a volatility controller arranged to receive a third set of one or more data streams comprising market data and to generate one or more signals for use in further modulating said modulated market allocation for the one or more tradeable objects based on a determined volatility metric value for the third set of one or more data streams.

25. A method of generating data indicative of a market allocation for one or more tradeable objects comprising:
processing a first set of one or more data streams comprising market data to generate data indicative of a value of a market indicator, the market indicator representing a predicted future trend and being used to determine data indicative of a market allocation for one or more tradeable objects;
processing a second set of one or more data streams comprising market data, including applying at least a risk classification to said second set of one or more data streams to generate one or more signals for use in modulating said data indicative of a market allocation for the one or more tradeable objects, the risk classification comprising the determination of a risk category; and
outputting data indicative of a modulated market allocation for the one or more tradeable objects based on the processing of the first and second sets of one or more data streams.
